(19) United States
(12) Patent Application Publication
(10) Pub. No.: US 2007/0242336 A1
(43) Pub. Date: Oct. 18, 2007

(54) Applications for mixing and combining light utilizing a transmission filter, iris, aperture apparatus

(76) Inventors: Vitaly Vodyanoy, Auburn, AL (US); Oleg Pustovyy, Auburn, AL (US)

Correspondence Address: HAVERSTOCK & OWENS LLP, 162 N WOLFE ROAD, SUNNYVALE, CA, 94086, US

(21) Appl. No.: 11/708,781

(22) Filed: Feb. 20, 2007

Related U.S. Application Data
(60) Provisional application No. 60/775,659, filed on Feb. 20, 2006.

(51) Int. Cl. G02B 26/02; G02B 27/10; G02B 5/22

(52) U.S. Cl. 359/234; 359/618; 359/889

(57) ABSTRACT

The present invention involves methods to combine light and apparatuses to accomplish the same. In some embodiments of the present invention, light from two light sources is combined to achieve multiple functions within one application. In some embodiments of the present invention, light from the light source is filtered using traditional high-contrast filters, transmission filters or the like. In some embodiments of the present invention, novel low contrast filters and variable contrast filters are used. These filters allow passing a light with a narrow frequency band of large intensity, while the broad spectrum light of smaller intensity is still passing through the filter. In some embodiments of the present invention, a strobing effect is used to combine light.

### RELATED APPLICATIONS

The present application claims priority to U.S. Provisional Patent Application 60/775,659, filed on Feb. 20, 2006, and entitled “Translational filter, shutter, aperture apparatus for selecting and combining filtered and unfiltered light” to the same inventors under U.S.C. section 119(e). This application incorporates U.S. Provisional Patent Application 60/775,659, filed on Feb. 20, 2006, and entitled “Translational filter, shutter, aperture apparatus for selecting and combining filtered and unfiltered light” to the same inventors by reference in its entirety.

### FIELD OF THE INVENTION

The present invention relates generally to the field of optical microscopy. More particularly, the invention relates to applications for mixing and combining light using a transmission filter, iris, aperture apparatus.

### BACKGROUND

Many applications exist which require light to be filtered and mixed. For example, traditional microscopy and macroscopy techniques often times use a combination of light to enhance the views and images seen by such apparatuses. Traditional brightfield microscopy, fluorescence microscopy, darkfield microscopy and applications in macroscopy are examples of such techniques which benefit from using mixed filtered light.

Brightfield microscopy is a simple microscopy technique which involves illumination of a sample, allowing the light to interact with the sample and gathering the resulting light in an objective lens. Differences in refractive index and opacity within the sample allow an image of that sample to be seen in the objective lens.

Fluorescent microscopy developed as a technique to take advantage of the fact that certain compounds fluoresce when exposed to light having a particular wavelength. Fluorescent microscopes can be useful to the study of bacteria, animal, and plant cells, as they show primary fluorescence (autofluorescence) when illuminated with ultraviolet light or specific fluorescence when combined with fluorescent molecules. Such microscopes bombard a sample with photons having an excitation frequency which matches the frequency that produces fluorescence in that particular sample. The sample then emits light which normally has a longer wavelength than that of the exciting light. Three important steps can divide the process of fluorescence. First, a molecule is excited by an incoming photon during the first few femtoseconds. During the next few picoseconds, the molecule goes through a vibrational relaxation of an excited state electron to the lowest energy level of the intermediate states. Finally, emission of a longer wavelength photon and recovery of the molecule into the ground state occurs during a few nanoseconds. The whole process from excitation of the molecule by an excitation light (EL) to emission of a longer wavelength fluorescent light (FL) is used for fluorescent microscopy.

The main function of a fluorescent microscope is to illuminate a sample with light of a specific wavelength (excitation light), excite the molecules of the sample with a fluorescent light, and then separate a weak emitted fluorescence from the excitation light, so that the emitted fluorescence can be observed.

The light of the wavelengths required for fluorescence excitation are traditionally selected by a single excitation filter, which transmits only exciting light and suppresses light of all other wavelengths. A certain part of the exciting light is adsorbed by the sample and almost instantaneously re-emitted at longer wavelengths as fluorescence light. A barrier filter transmits the fluorescence light (emission light). The rest of the excitation light which passes through or reflects from the sample is absorbed by the barrier filter. As a result, a color image of the sample is observed (or recorded) against a dark background.

Early fluorescence microscopes were generally brightfield transmitted light microscopes equipped with excitation and barrier filters. Brightfield microscopy involves shining incident light directly onto a sample.

Darkfield microscopy is another technique used to increase the contrast in the images of a certain sample. The darkfield technique utilizes a darkfield condenser which takes in light from a light and projects light out at oblique angles. This results in a hollow inverted cone of light whose tip passes through the sample, but which diverges such that the incident light does not enter the objective lens of the microscope. This results in an image which appears bright against a dark background.

A number of problems exist in these techniques. First, when using a brightfield microscope or darkfield interference technique, the full-spectrum light typically over shines any fluorescence emitted by the sample.

Next, when using a filter for fluorescence microscopy, the filter can either be ‘on’ or ‘off’ as a filter is physically inserted or removed from an optical train. This limitation often times restricts a scientist's ability to simultaneously observe all parts of a sample, both the parts with a fluorescent tag and those without such a tag. For example, a scientist wishing to view the nucleus of a particular cell may use a blue filter to observe a cell whose nucleus fluoresces green with blue light. However, blue light illuminating the other parts of the cell is blocked by the emission filter. Therefore, the scientist can either choose to view the nucleus or the surrounding cellular features, but not both simultaneously.

Macroscopy, similar to microscopy, can use fluorescent, darkfield or brightfield techniques to observe larger objects, such as whole organisms or tissues. However, the current state of microscopy and macroscopy requires a scientist to take a number of still shots of an object at different frequencies and overlay the still images in order to get a full image.

### SUMMARY OF THE DISCLOSURE

The present invention involves methods to combine light and apparatuses to accomplish the same. In some embodiments, the light is combined to be used in microscopy applications, however, any application which may utilize mixed and combined light will benefit from the present invention.

In some embodiments of the present invention, light from two light sources are combined. In some embodiments of the present invention, light from one light source is filtered to be used to excite fluorescence in a sample and light from another light source is full-spectrum light. In some embodiments of the present invention, the light from the two light sources are combined at a sample. In other embodiments, the light from the two light sources are combined at a mirror. In some embodiments of the present invention, the two light sources comprise one light source integrated in the illumination system and a second light source module which couples with the illumination system.

In some embodiments of the present invention, light from the light source is filtered using traditional high-contrast filters, transmission filters or the like. In some embodiments of the present invention, multiple filters are utilized. In some embodiments of the present invention, light is blocked, obstructed or redirected using apertures, irises, lenses, collimators or the like. In some embodiments of the present invention, parabolic mirrors are utilized to direct light. In some embodiments of the present invention light guides are used to carry light.

In some embodiments of the present invention, novel low contrast filters and variable contrast filters are used. These filters allow passing a light with a narrow frequency band of large intensity, while the broad spectrum light of smaller intensity is still passing through a filter. In some embodiments of the present invention, the range of wavelengths is fine tunable using multiple filters having different contrasts or variable contrasts.

In some embodiments of the present invention, a strobing effect is used to combine light. A method of observing moving macroscopic samples in real time is disclosed and accomplished using the strobing effect.

### BRIEF DESCRIPTION OF THE DRAWINGS

The novel features of the invention are set forth in the appended claims. However, for the purpose of explanation, several embodiments of the invention are set forth in the following figures.

FIG. 1A illustrates a side view of a microscope lighting system utilizing two light sources according to some embodiments of the present invention.

FIG. 1B illustrates a side view of a microscope lighting system utilizing two light sources according to other embodiments of the present invention.

FIG. 2 illustrates a side view of a microscope lighting system utilizing two light sources and a combining mirror according to some embodiments of the present invention.

FIG. 3 illustrates a side view of a microscope with an internal lighting system utilizing an optional second light source combined at the mirror according to some embodiments of the present invention.

FIG. 4A illustrates a top view of a light box utilizing two light sources according to some embodiments of the present invention.

FIG. 4B illustrates a top view of a light box utilizing two light sources according to other embodiments of the present invention.

FIG. 5A illustrates a schematic representation of the spectral distribution of incident light using a high contrast optical filter according to some embodiments of the present invention.

FIG. 5B illustrates a schematic representation of the spectral distribution of incident light using a low contrast optical filter according to some embodiments of the present invention.

FIG. 6A illustrates a front view of a filter with a fluorescent portion and a clear annular zone according to some embodiments of the present invention.

FIG. 6B illustrates a front view of a filter with a fluorescent portion and a clear annular zone, with an adjustable iris, according to some embodiments of the present invention.

FIG. 6C illustrates a front view of a variable contrast filter according to some embodiments of the present invention.

FIG. 6D illustrates a front view of a variable contrast filter according to some embodiments of the present invention.

FIG. 6E illustrates a front view of a plate of filters according to some embodiments of the present invention.

FIG. 6F illustrates a front view of a variable contrast filter in a plate configuration according to some embodiments of the present invention.

FIG. 6G illustrates a front view of a variable contrast filter according to some embodiments of the present invention.

FIG. 6H illustrates a front view of a variable contrast filter according to some embodiments of the present invention.

FIG. 7 illustrates a strobing configuration for mixing separate light sources according to some embodiments of the present invention.

### DETAILED DESCRIPTION

The present invention allows researchers and scientists to combine light for producing fluorescent images and full-spectrum using multiple light sources, filters with different contrasts or with variable contrasts, apertures and irises and strobe techniques. The proportions of the allowed individual wavelengths and full-spectrum light, and also their relative intensities are fine-tunable.

It is desirable to utilize two types of light in certain applications which require a portion of light for one aspect of the application and a different portion of light for another aspect of the application. For instance, in the field of microscopy, it is sometimes beneficial to illuminate a sample with light filtered for a certain wavelength or range of wavelengths and also with full-spectrum light. In such an application, the filtered light creates fluorescence in the sample and the full-spectrum light produces an image of the rest of the sample by interacting with the differences in refractive index and opacity of the sample.

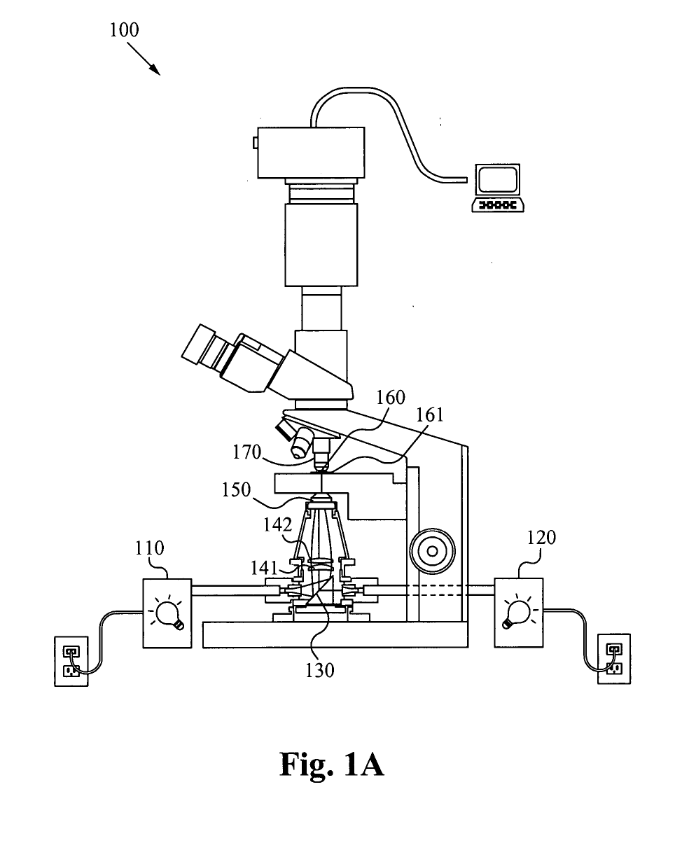

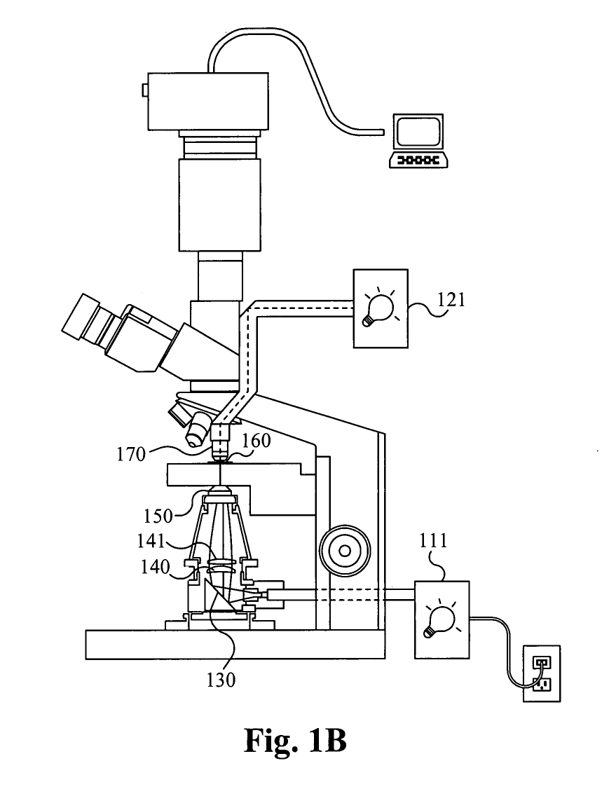

In some embodiments of the present invention, two light sources are utilized to produce the two types of light. FIG. 1A illustrates a side view of a microscope 100 with an illumination system in which two light sources 110, 120 are utilized.

As shown, the light source 110 directs a cone of illumination onto a mirror 130, the cone is reflected, and focused with the lens 141 and the lens 142 to a darkfield condenser 150 to provide the sample 160 with darkfield illumination. The light source 120 provides the sample with light for fluorescent illumination of the sample 160 and is collected by the objective lens 170.

In this embodiment, light is also directed from the light source 120 to the mirror 130, up through the lenses 141 and 142, straight through the condenser 150 and incident on a sample 160. The mirror does not mix light from the light source 110 and the light source 120 because the light from light source 110 is a hollow cone of light and the light from light source 120 is a solid beam of light which fits within the hollow cone. Instead, the light is mixed at the sample 160.

According to this embodiment of the present invention, the light source 110 utilizes full-spectrum light and the light source 120 utilizes fluorescent light. The power and level of intensity of the light from the light source 110 is adjustable, allowing the light source to be fine-tuned so as not to over shine the fluorescent image. In some embodiments of the present invention, a number of filters, diaphragms, aperture stops or irises are used to adjust the light.

In some embodiments, the light source 110 or 120 is a high-intensity discharge (HID) lamp such as Ceramic discharge metal halide lamps, Hydrargyrum medium-arc iodide (HMI) lamps, Mercury-vapor lamps, Metal halide lamps, Sodium vapor lamps or Xenon arc lamps. However, it will be apparent to those skilled in the art that any other appropriate light source is similarly envisioned.

FIG. 1B illustrates another embodiment of the present invention which combines light from the two light sources 111 and 121 at the sample 160. As shown, the light source 111 directs a cone of illumination onto a mirror 130, the cone is reflected, and focused with the lens 141 and the lens 142 to a darkfield condenser 150 to provide the sample 160 with darkfield illumination. The light source 121 provides the sample with light for fluorescent illumination of the sample 160. Light is directed down from the light source 121 directly to the sample 160. The light from the light source 121 produces emitted light that bounces off the sample 160 and is collected by the objective lens 170.

The light source 111 preferably utilizes full-spectrum light and the light source 121 utilizes fluorescent light. The power and level of intensity of the light from the light source 111 is adjustable, allowing the light source to be fine-tuned so as not to over shine the fluorescent image.

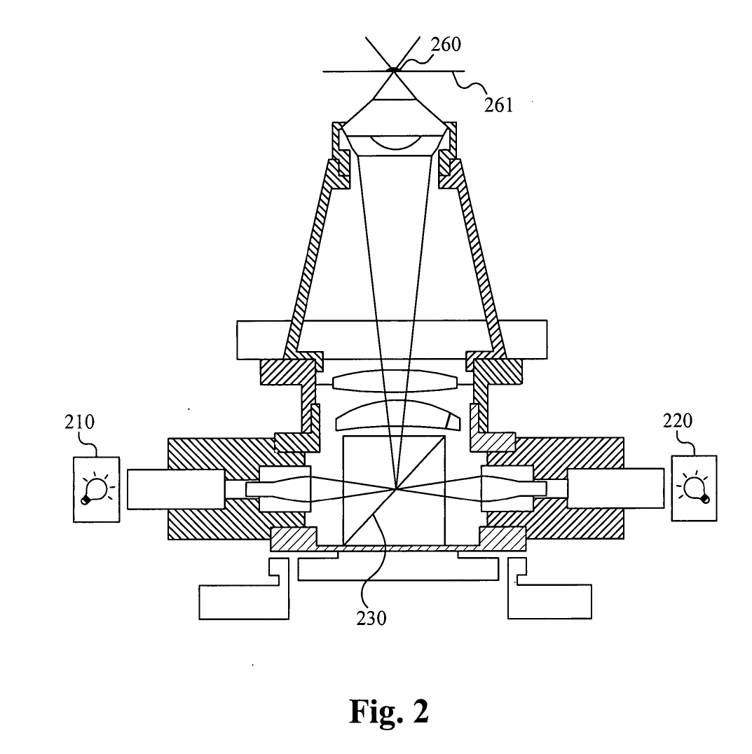

FIG. 2 illustrates another method of combining light using the two light sources 210, 220 which are mixed with a mirror 230. In FIG. 2, light from the light source 210 and the light from light source 220 are directed toward the mirror 230. The mirror 230 mixes the light and directs the resultant light up toward the stage 261 and the sample 260. Although FIG. 2 depicts light being mixed as it falls incident upon the mirror 230 from the right and left, it is also conceived that light is able to be mixed as it hits the mirror from other directions including into or out of the page.

In some embodiments of the present invention, collimating lenses, filters, diaphragms, aperture stops or irises are used to adjust the light before falling incident upon the mirror.

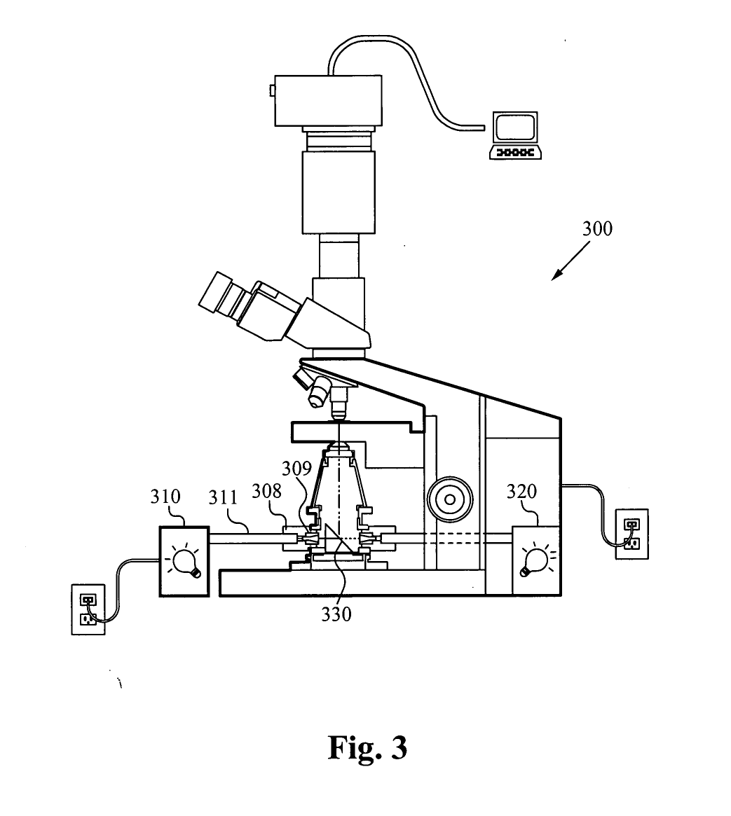

FIG. 3 illustrates another dual light source light mixing system according to some embodiments of the present invention. Here, light is being mixed with a mirror 330 to be used in a microscope 300. The microscope 300 has an integrated light source 320 and a port 309 for the introduction of an optional second light source. As shown, a modular light source 310 is coupled a light guide 311 and to the port 309. In some embodiments of the present invention, the light guide 311 is an optical fiber. In some embodiments, light from the light guide 311 is collimated by a collimator 308 before entering the port 309. The modular light source 310 is selected according to the desired frequency and desired intensity of the light it produces. In some embodiments, the modular light source 310 provides full-spectrum light. In some embodiments, the light source 310 provides full-spectrum light which is filtered. In other embodiments, the light source 310 is a high-intensity discharge (HID) lamp such as Ceramic discharge metal halide lamps, Hydrargyrum medium-arc iodide (HMI) lamps, Mercury-vapor lamps, Metal halide lamps, Sodium vapor lamps or Xenon arc lamps. However, it will be apparent to those skilled in the art that any other appropriate light source is similarly envisioned. Furthermore, it will be readily apparent to those skilled in the art that the modular light source can utilize filters, irises, aperture stops and the like.

In FIG. 3, light from the light source 310 and the light source 320 are directed toward the mirror 330. The mirror 330 mixes the light and directs the resultant light up toward the sample. Although FIG. 3 depicts light being mixed as it falls incident upon the mirror 330 from the right and left, it is also conceived that light is able to be mixed as it hits the mirror from other directions including into or out of the page.

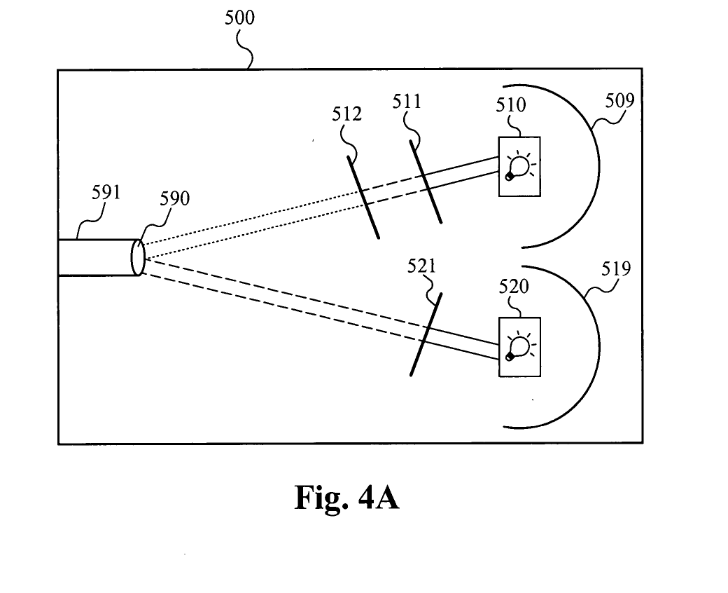

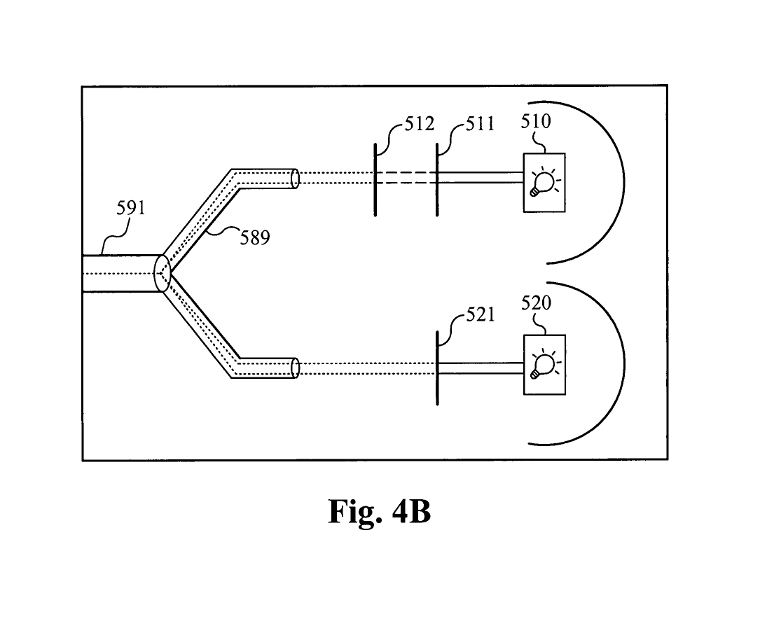

FIGS. 4A-4B illustrate other dual light source light mixing systems using two light sources in one light box according to some embodiments of the present invention. FIG. 4A is a top view of the light box 500. The light box 500 houses the two light sources 510 and 520. The light sources 510, 520 are partially encircled by the parabolic mirrors 509 and 519, respectively. The parabolic mirrors 509, 519 are positioned such that they direct light to the exit port 590, but are also positioned so as to prevent light from one light source interfering prematurely with the light from the other light source.

Light from the light source 510 is directed first to an infrared filter (IR) 511. Next, the light falls incident on the filter 512. In some embodiments of the present invention, the filter 512 filters out particular wavelengths of light. In other embodiments of the invention, the filter 512 is a transmission filter, iris and aperture apparatus, as described above. The light remaining after filtration is directed to the exit port 590.

The IR filter 511 filters out certain wavelengths from the light which tend to cause heating problems. In some embodiments, a neutral-density filter is used to achieve this goal.

Light from the light source 520 is directed first to an infrared filter (IR) 521. The IR filter 521 filters out certain wavelengths from the light which tend to cause heating problems. Next, the light is directed to the exit port 590. A light guide 591 is coupled to the exit port 590. The light entering the exit port 590 from both of the light sources 510 and 520 are mixed in the light guide 591. In some embodiments of the present invention, the light guide 591 is an optical fiber.

FIG. 4B illustrates another example of a dual light source light mixing system using two light sources in one light box. The light box of FIG. 4B houses the two light sources 510 and 520. The light sources 510, 520 are partially encircled by the parabolic mirrors which are positioned such that they direct light separately to the receiving prongs of the two-prong light guide 589. In FIG. 4B, light from the light source 510 is first filtered with an IR filter 511 and next filtered by the filter 512. The resulting light is directed to one receiving prong of a two-prong light guide 589. Light from the light source 520 is filtered by the IR filter 521 and directed to the other receiving prong of the light guide 589. The light guide 589 directs the light to the light guide 591 where it is mixed.

The above embodiments describe applications for mixing and combining light utilizing two light sources. It will be clear to those of ordinary skill in the art that any number of light sources are able to be utilized using the same methods disclosed herein if such illumination is desired.

In other embodiments of the present invention, methods for mixing light which preferably utilize only one light source are disclosed. It will become clear to those of ordinary skill in the art that any appropriate number of light sources may always be substituted for one light source without departing from the invention disclosed herein.

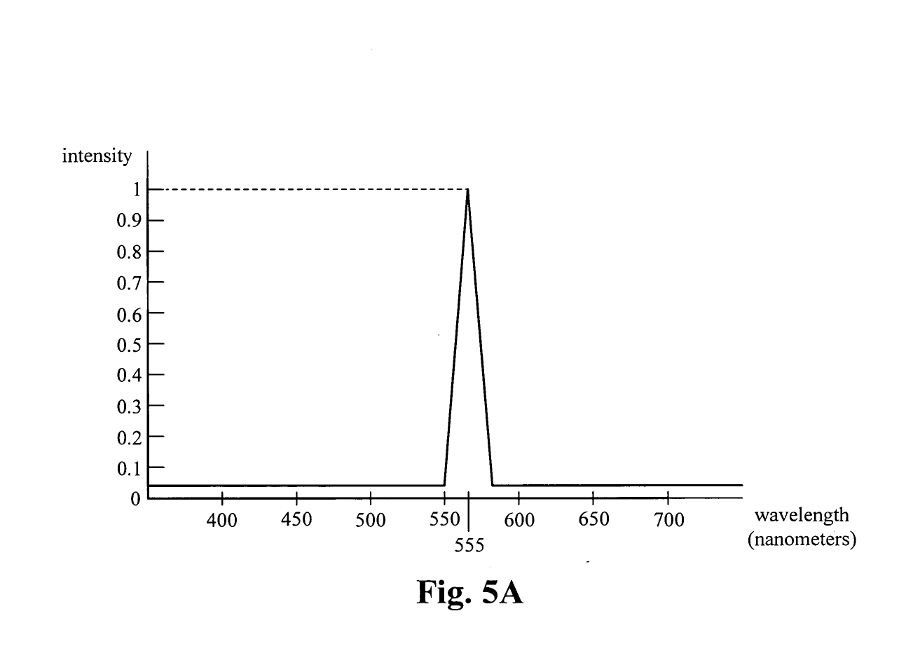

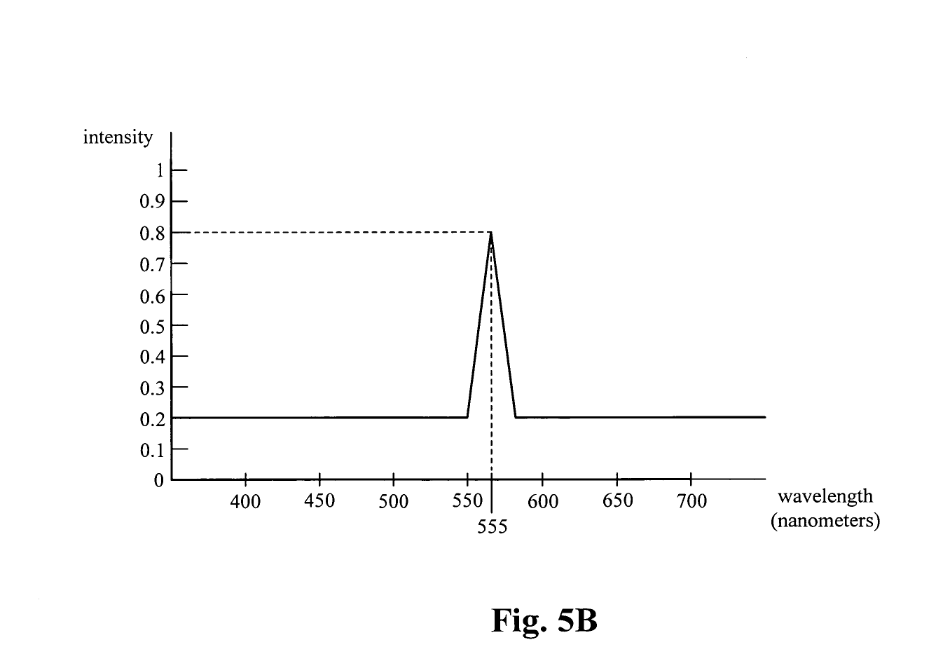

Mixing light may also be accomplished using one light source, filtering parts of the light source and recombining the filtered light. One way to filter light is to use commercial off the shelf filters. Typical commercial off the shelf filters are available with high contrast. Contrast describes the percentage of light the filter allows therethrough having only the desired wavelength or wavelengths compared to the percentage of light that passes through having other wavelengths. For instance, when green light is utilized in some applications, a 555 nanometer filter might be utilized. Such a filter might be available commercially with a 90% contrast, meaning 90% of the light coming out of the filter has a wavelength of 555 nanometers while 10% has other wavelengths. FIG. 5A is a schematic representation of the spectral distribution for light exiting a typical commercial off the shelf 555 nanometer filter. As shown, a peak of light is allowed around 555 nanometers with only a small amount of light with other wavelengths allowed.

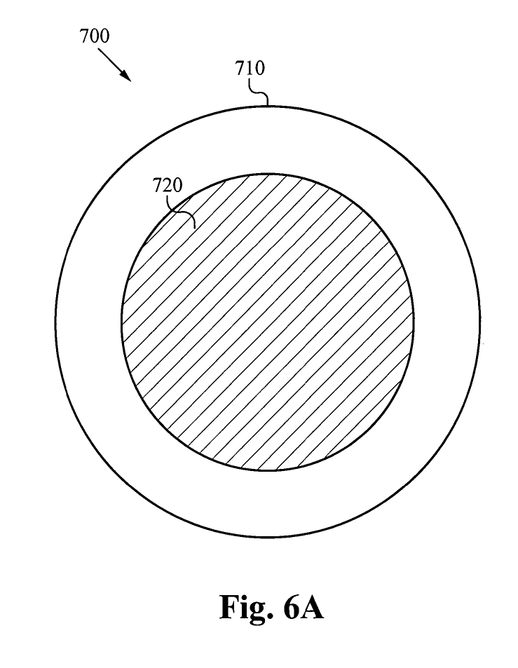

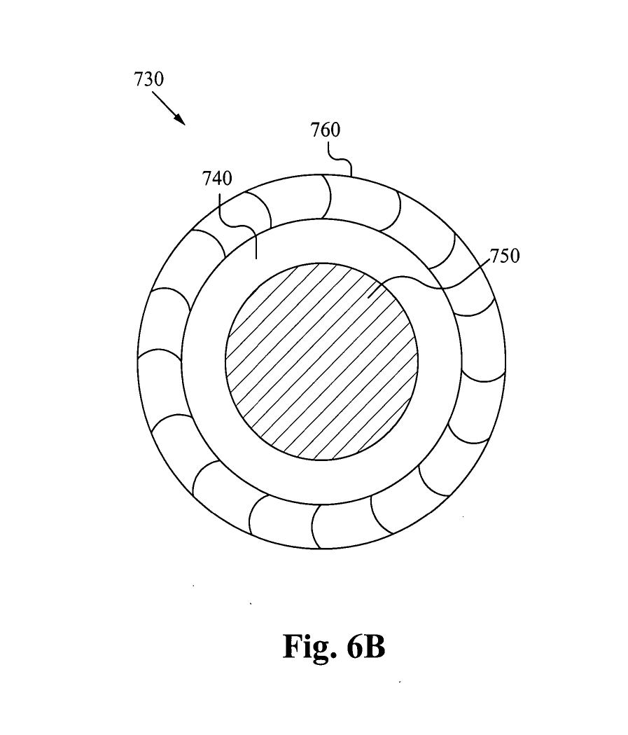

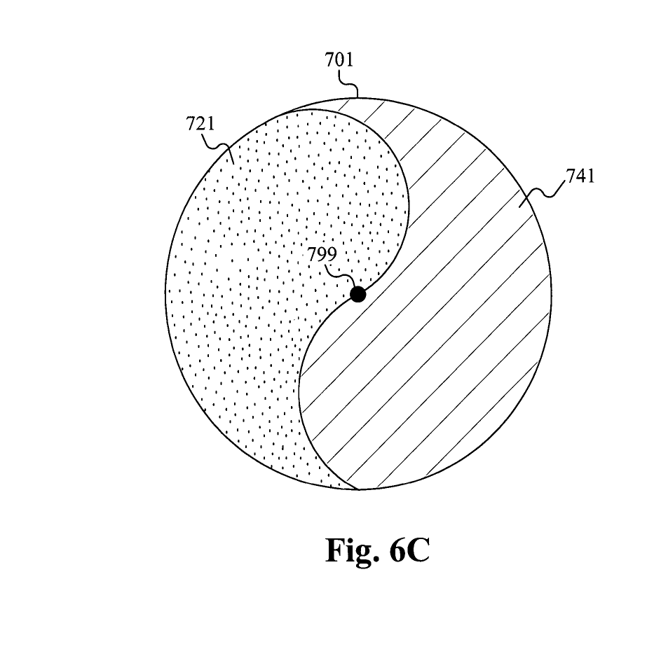

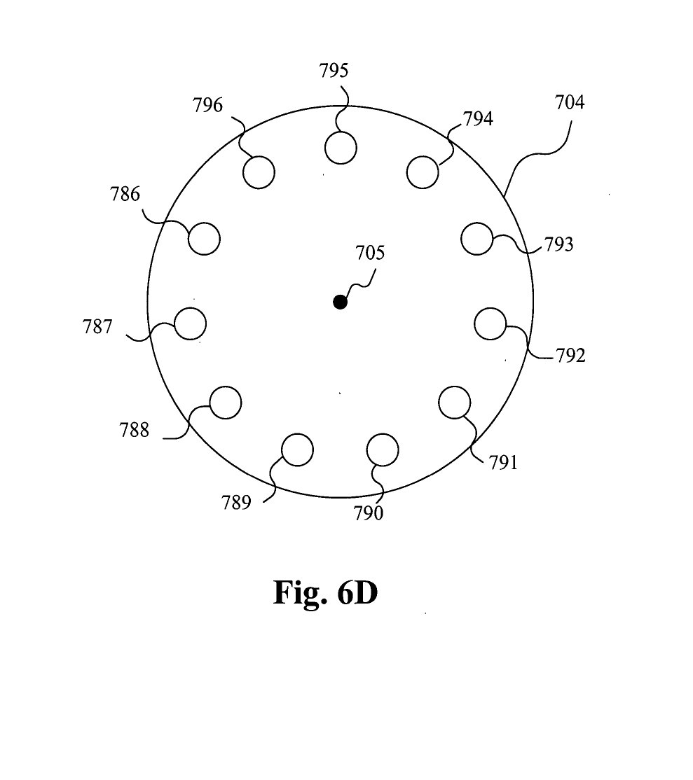

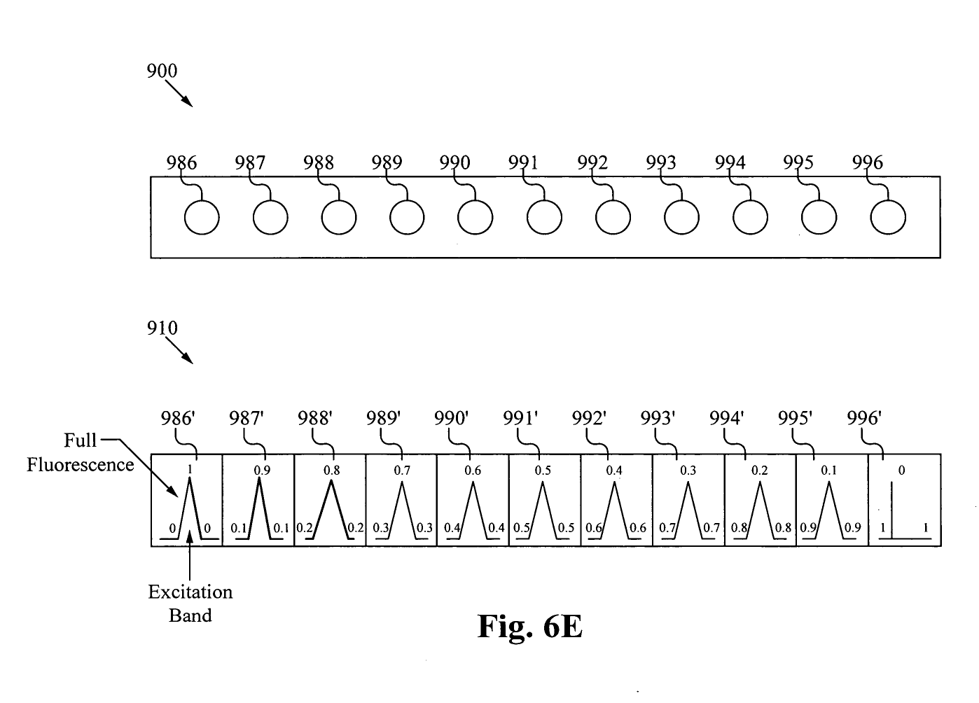

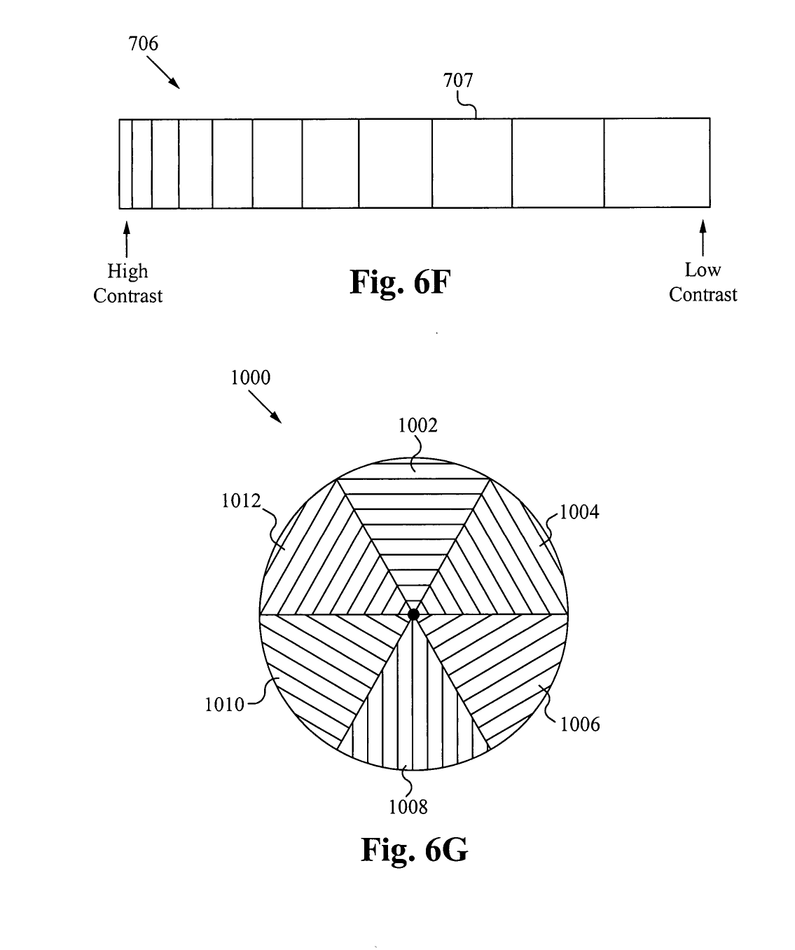

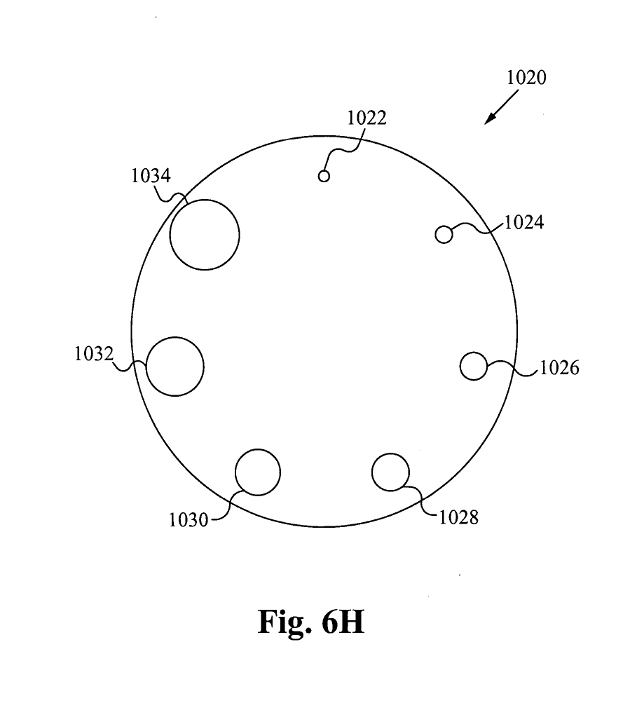

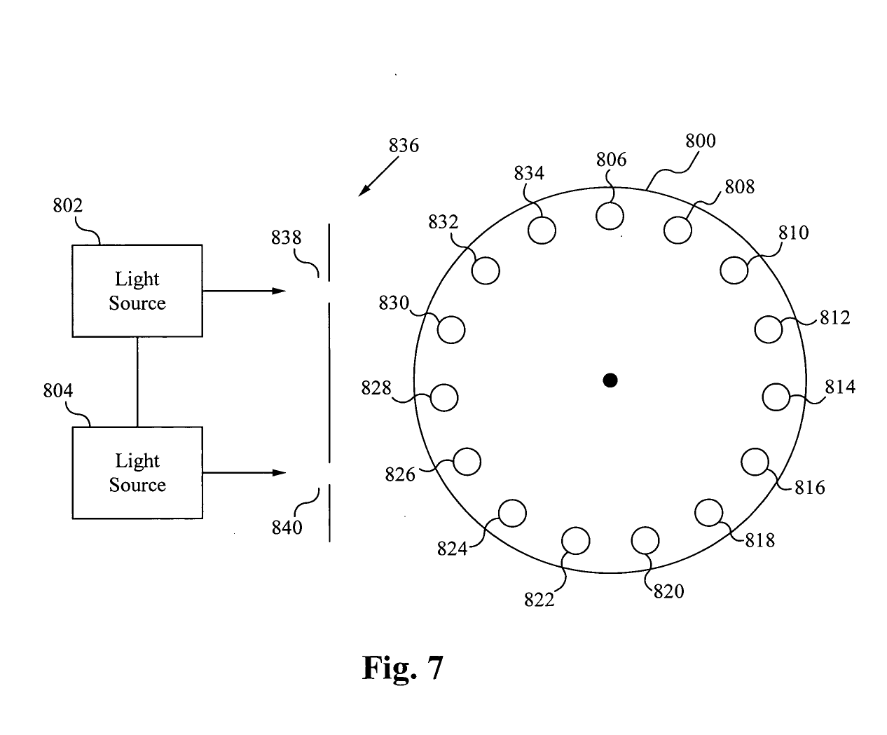

The present invention also utilizes filters with low contrast in order to achieve objects of the invention. The state of the art teaches away from using such filters, as they are generally regarded as inferior to high contrast filters. However, since low contrast filters allow a more full range of frequencies to pass through, while still ensuring that some light passing through will have one frequency, these low contrast filters are preferred in applications which require a range of frequencies. For example, in the field of optical microscopy, it is sometimes desirable to use some light having a wavelength of 555 nanometers to excite fluorescence and also to use other wavelengths to produce brightfield images. A low contrast filter, which allows a fair amount of green light through and a fair amount of full-spectrum light through, would be effective in such an application. FIG. 5B is a schematic representation of the spectral distribution for light exiting a low contrast 555 nanometer filter. As shown, a peak of light is allowed around 555 nanometers with a substantial amount of light with other wavelengths allowed. Various filters, irises and apertures which are able to achieve low contrast or variable contrast are disclosed below in FIGS. 6A-6H.

FIG. 6A illustrates a filter 700 according to some embodiments of the present invention. The filter 700 is comprised of an outside clear annular zone 710, and a fluorescent portion of the filter 720. This filter 700 provides a combination of darkfield, through the clear annular zone 710, and fluorescent images, through the fluorescent portion of the filter 720.

FIG. 6B illustrates a filter 730 according to some embodiments of the present invention. The filter 730 is comprised of an outside clear annular zone 740, with an adjustable iris 760, and a fluorescent portion of the filter 750. This filter 730 also provides a combination of darkfield, through the clear annular zone 740, and fluorescent images, through the fluorescent portion of the filter 750. The adjustable iris 760 allows a user to reduce a darkfield image of a transmitted beam of light. For example, the iris 760 can be reduced to provide more fluorescence. If the iris 760 is reduced to the size of the filter 750, only fluorescent images will pass. Conversely, the iris 760 can be opened to provide more darkfield or scattered images. That is, as the iris 760 is opened further, more spectrum of light can pass through, providing some combination of darkfield and fluorescent images.

FIG. 6C illustrates another embodiment of a variable contrast filter 701 according to some embodiments of the present invention. The filter 701 has a “ying-yang” configuration with the “ying” portion 721 having one contrast and the “yang” portion 741 having a second contrast. In one example, the “ying” portion 721 comprises a full fluorescent filter and the “yang” portion 741 comprises a full transparent section. The filter 701 is configured to rotate about an axis 799. The filter 701 rotates through an incident light path. As the filter 701 rotates, the light path falls incident upon different proportions of the “ying” contrast and the “yang” contrast. As such, the proportion of wavelengths allowed through the filter changes.

FIG. 6D illustrates a calibrated variable contrast filter 703 according to some embodiments of the present invention. The calibrated variable contrast filter 703 is a disk 704 with the filters 786-796 around its circumference. Each filter 786-796 is calibrated to filter a particular wavelength of light at some particular contrast. In one particular embodiment, the filters 786-796 filter 555 nanometer light between 0% and 100% contrast. The calibrated variable contrast filter 703 rotates about the axis 705, and a light path (not shown) falls incident upon its surface. The filters 786-796 each fully eclipse the light path one at a time during a full rotation, and as such, the light is filtered in the amount of each filter calibration.

FIG. 6E illustrates a plate of filters 900. This plate of filters 900 includes filters 986-996, corresponding to the filters 786-796 of the disk 704 of FIG. 6D. The plate of filters 900 (FIG. 6E) and the disk of filters 704 (FIG. 6D) represent alternative configurations of filters with different contrasts. Further alternative configurations of the filters with different contrasts are also possible including a plate with a grid arrangement of filters that are to be moved in two dimensions. A first filter can include an excitation band which passes full fluorescence. A final or last filter of the series of filters can include an excitation band which passes all scattered or darkfield images. Filters positioned in between can each include excitation bands that pass some combination of both fluorescence and darkfield images.

In the configurations of FIGS. 6D and 6E, the filters 986-996 include different excitation bands as represented by the graphs 986′-996′. The first filter 986 includes an excitation band which passes full fluorescence, with no scattered or darkfield images. The second filter 987 includes an excitation band that passes 90% fluorescent images and 10% darkfield images. The third filter 988 includes an excitation band that passes 80% fluorescent images and 20% darkfield images. The fourth filter 989 includes an excitation band that passes 70% fluorescent images and 30% darkfield images. The fifth filter 990 includes an excitation band that passes 60% fluorescent images and 40% darkfield images. The sixth filter 991 includes an excitation band that passes 50% fluorescent images and 50% darkfield images. The seventh filter 992 includes an excitation band that passes 40% fluorescent images and 60% darkfield images. The eighth filter 993 includes an excitation band that passes 30% fluorescent images and 70% darkfield images. The ninth filter 994 includes an excitation band that passes 20% fluorescent images and 80% darkfield images. The tenth filter 995 includes an excitation band that passes 10% fluorescent images and 90% darkfield images. The eleventh filter 996 passes all darkfield images.

FIG. 6F illustrates yet another variable contrast filter 706 in a plate configuration 707 according to some embodiments of the present invention: a gradient contrast filter. The variable contrast filter 706 is comprised of the plate 707 having a filter with a contrast gradient from high contrast on the left and low contrast on the right, in the exemplary configuration of FIG. 6F. The filter's contrast ranges from 0% to 100%. As the variable contrast filter 706 moves through the light path, the contrast changes.

FIG. 6G illustrates a filter 1000 comprised of multiple sectors 1002, 1004, 1006, 1008, 1010 and 1012. Each of the sectors 1002, 1004, 1006, 1008, 1010 and 1012 of the filter of FIG. 7H, includes a different contrast.

FIG. 6H illustrates a filter 1020 including holes of different diameters to produce a combination of full fluorescence and scattered images. The filter 1020 is a fluorescent filter to pass fluorescent images, with the holes 1022, 1024, 1026, 1028, 1030, 1032 and 1034 providing apertures to pass darkfield or scattered images. The holes 1022, 1024, 1026, 1028, 1030, 1032 and 1034 of the Filter 7I, each have a different diameter and can be selectively used to produce an appropriate combination of full fluorescence and scattered images. The circular filter 1020 is also able to be rotated.

It will be clear to those ordinarily skilled in the art that various irises, apertures or filters can be used with the above embodiments. Further it will be readily apparent that the movement of the filters, irises or apertures described above is able to be achieved mechanically, electronically, or both. Further, the movement of the filters, irises or apertures are able to be controlled with a computer.

It will be clear to those ordinarily skilled in the art that the filters can take many shapes and sizes. Further, it will be readily apparent that successively placed filters may be used to further tune the overall contrast.

FIG. 7 illustrates a strobing configuration for mixing separate light sources. The strobing configuration of FIG. 7 includes the light source 802, the light source 804 and the rotatable filter wheel 800 which includes the filters and holes 806-834. The strobing configuration includes a screen 836 having a slit 838 and a slit 840. In this exemplary configuration, the light source 802 transmits light through the first slit 838 and the second light source 804 transmits light through the second slit 840. The first light source 802 is a fluorescent light source and the second light source 804 is a full spectrum light source. After passing through the slits 838 and 840, then, the lights pass through at least one of the holes or filters as the wheel 800 is rotated. The rotatable wheel 800 can be rotated at certain speeds, creating different ratios of holes and filters through which the light from the light sources 802 and 804 pass. In this configuration, the lights can mix at any desired proportion, depending on the speed of the wheel 800 and the combination of filters and holes 806-834. Visually, as the lights pass through the rotatable wheel 800, a user is able to see both fluorescence and full spectrum images. This strobing configuration allows each filter to be exposed to light for a short time, and then cooling when not passing light. Alternatively, any number of light sources, including a single light source, and filters and holes, can be included in the strobing configuration.

The strobing effect according to some embodiments of the present invention provides a way for a user to observe dynamic processes in real time using proportionally filtered light. Also, the present invention provides practitioners of microscopy the ability to observe a sample in real time by using a mixture of light frequencies.

The disclosed invention involves methods and apparatuses to combine light for applications utilizing mixed and combined light. In this field of art there is a need for methods to mix fluorescent and full-spectrum light. Some embodiments of the present invention fulfill this need by utilizing two light sources to produce light. In some embodiments one light is filtered for fluorescence and one light is used as full-spectrum or as wide-spectrum light. A transmission filter, aperture and iris is able to fine tune the allowed frequency range for each light source. In some embodiments, the filtered light and the wide-spectrum light are mixed at the sample. In other embodiments, the filtered light and the wide-spectrum light are mixed with a mirror.

In some embodiments, one of the light sources is an internal light source and the other light source is an external module light source. This configuration allows convenient swapping of the second light source according to the application being performed.

In some embodiments, both the wide-spectrum light and the fluorescent light are produced in an external module light box. Parabolic mirrors ensure that the light is properly filtered and mixed.

In some embodiments the fluorescent light and the wide-spectrum light are produced using a low-contrast filter. The state of the art teaches away from using low-contrast filters in such optical applications, assuming that high contrast is superior. However, when the goal of the application is to produce light with some portion having a high intensity peak about one frequency and also having a portion with a wide-spectrum of frequencies, low contrast filters are actually preferable.

In some embodiments, a variable contrast filter is utilized. Such embodiments and apparatuses are able to fine tune the portion of light having a high intensity peak and the portion of light having a wide-spectrum of frequencies.

In other embodiments, a strobing method of filtering allows users to observe moving processes by controlling the frequency and power of each strobe of light.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

What is claimed is:

1. A method of combining light comprising:
a. transmitting an unfiltered light and a filtered light to a mirror in an illumination system; and
b. mixing the lights on a sample.

2. A method of combining light comprising:
a. transmitting an unfiltered light and a filtered light to a mirror in an illumination system; and
b. mixing the lights on the mirror.

3. A method of combining light comprising:
a. transmitting a first light from a first light source through a first filter and a fluorescent filter;
b. transmitting a second light from a second light source through a second filter; and
c. mixing the lights in the light guide.

4. The method of claim 3 wherein the first light and the second light are focused on an entrance port of the light guide.

5. The method of claim 3 wherein the first light is focused on a first entrance port of the light guide and the second light is focused on a second entrance port of the light guide.

6. The method of claim 3 wherein the first filter comprises an infrared filter.

7. A filter for combining filtered and unfiltered light, comprising:
an inner fluorescent portion; and
a transparent outer surface,
wherein when light passes through both the inner portion and the outer surface, images, produced by filtered and unfiltered lights, are combined.

8. The filter of claim 7 further including an iris diaphragm for covering a portion of the outer surface of the filter, wherein the diaphragm controls a ratio between intensity of filtered and unfiltered lights.

9. An apparatus for combining filtered and unfiltered light, comprising:
one or more filters, each filter having a discrete contrast ratio, wherein a transmitted light is filtered according to the contrast ratio of each filter.

10. The apparatus of claim 9 wherein the one or more filters are housed in a plate configuration.

11. The apparatus of claim 9 wherein the one or more filters are housed in a wheel configuration.

12. The apparatus of claim 10 wherein the plate is positioned so that one of the filters transmits the light one at a time.

13. The apparatus of claim 11 wherein the wheel is positioned so that one of the filters transmits the light one at a time.

14. A filter for combining filtered and unfiltered light, comprising:
at least one or more holes of different diameters to produce an outcoming light beam with different ratios of filtered and unfiltered light intensities.

15. The filter of claim 14 wherein a diameter of an incoming light beam is equal or greater than a smallest hole of the one or more holes.

16. An apparatus for combining filtered and unfiltered light, comprising:
a first light source;
a second light source;
a screen having at least one slit; and
a rotatable wheel having at least one filter and at least one hole, such that when the first and second light sources pass through the at least one or more holes and filters, the wheel is rotated at predetermined speeds, using a strobing effect to combine light.
